(19) United States
(12) Patent Application Publication
(10) Pub. No.: US 2021/0170524 A1
(43) Pub. Date: Jun. 10, 2021

(54) LASER BEAM ADJUSTMENT SYSTEM AND LASER PROCESSING APPARATUS

(71) Applicant: DISCO CORPORATION, Tokyo (JP)

(72) Inventor: Tsubasa OBATA, Tokyo (JP)

(21) Appl. No.: 17/101,176

(22) Filed: Nov. 23, 2020

(30) Foreign Application Priority Data
Dec. 5, 2019 (JP) 2019-220383

(51) Int. Cl. B23K 26/06; B23K 26/70; B23K 26/08; B23K 26/082

(52) U.S. Cl. CPC B23K 26/0648; B23K 26/705; B23K 26/082; B23K 26/0853; B23K 26/0665; B23K 26/0643

(57) ABSTRACT

A laser beam adjustment system for adjusting a laser beam to a parallel light. The system includes a beam adjustment unit having a plurality of lenses arranged in an optical path of the laser beam and, first and second mirrors that reflect the laser beam having passed through the beam adjustment unit, first and second cameras configured to capture images of a first light having passed through the first mirror and a second light having passed through the second mirror, calculation sections configured to calculate first and second beam diameters of the first light and second light from the images captured by the first and second cameras, and a lens adjustment section configured to move one of the lenses of the beam adjustment unit in a direction parallel to the optical path of the laser beam so that the first and second beam diameters match each other.

### BACKGROUND OF THE INVENTION

### Field of the Invention

The present invention relates to a laser beam adjustment system and a laser processing apparatus.

### Description of the Related Art

Among laser processing apparatuses that process a workpiece by irradiating the workpiece with a laser beam, there are apparatus differences that the beam diameter of a laser beam emitted from a laser oscillator varies from laser oscillator to laser oscillator. Therefore, a beam expander is used to adjust the beam diameter of the laser beam to a preset diameter and also to adjust the laser beam to a parallel beam of light, which is hereinafter referred to simply as “a parallel light.”

A beam expander adjusts a laser beam to a parallel light, and also adjusts the beam diameter of the laser beam to a predetermined size. Use of the beam expander can make the diameter of a laser beam emitted from a laser oscillator substantially uniform among apparatuses. The apparatus differences among laser processing apparatuses can be reduced accordingly.

In a beam expander, a first concave lens, a convex lens and a second concave lens are arranged side by side in this order from a laser oscillator as disclosed in Japanese Patent Laid-open No. 1996-015625. Focal points of the individual lenses are located on the same optical axis.

### SUMMARY OF THE INVENTION

The beam diameter of a laser beam in a laser processing apparatus is measured from a reacted area on a photodetector (power meter) by irradiating the photodetector with the laser beam as disclosed in Japanese Patent Laid-open No. 1996-015625.

An adjustment of a laser beam by a beam expander is performed before processing as will be described hereinafter. First, a worker performs an adjustment to convert a laser beam to a parallel light or to a collimated beam by moving a lens. Next, the worker measures the beam diameter, and performs an adjustment to change the beam diameter of the laser beam to a predetermined size (beam diameter adjustment) by moving another lens. When this beam diameter adjustment is performed, the parallelism is broken so that an adjustment to a parallel light and a beam diameter adjustment are performed again. As described above, the worker repeats an adjustment to a parallel light and a beam diameter adjustment to obtain a desired parallelism and beam diameter for a laser beam. It therefore takes labor and time for the adjustment of a laser beam by a beam expander.

If the laser beam becomes no longer the parallel light or varies in beam diameter during processing, the worker is hard to notice such a change because the adjustment to a parallel light and the beam diameter adjustment, which uses the photodetector, are performed before the processing.

The present invention therefore has as an object thereof the provision of a laser beam adjustment system that can facilitate an adjustment to a parallel light and a beam diameter adjustment for a laser beam and, if the laser beam varies in beam diameter during laser processing, allows a worker to notice such a change.

In accordance with an aspect of the present invention, there is provided a laser beam adjustment system for adjusting a laser beam emitted from a laser oscillator to a parallel light. The laser beam adjustment system includes a beam adjustment unit having a plurality of lenses arranged in an optical path of the laser beam, a first mirror that reflects the laser beam, which has passed through the beam adjustment unit, to change the optical path thereof, a second mirror that reflects the laser beam, the optical path of which has been changed by the first mirror, to change the optical path thereof, a first camera configured to capture an image of a first light having passed through the first mirror, a second camera configured to capture an image of a second light having passed through the second mirror, and a control unit. The control unit includes a first calculation section configured to calculate a first beam diameter of the first light from pixels in a region having a higher brightness than a preset first brightness in the image captured by the first camera, a second calculation section configured to calculate a second beam diameter of the second light from pixels in a region having a higher brightness than a preset second brightness in the image captured by the second camera, and a lens adjustment section configured to move one of the plurality of lenses of the beam adjustment unit in a direction parallel to the optical path of the laser beam so that the first beam diameter calculated by the first calculation section and the second beam diameter calculated by the second calculation section match each other.

Preferably, the lens adjustment section may be configured to move another one of the plurality of lenses of the beam adjustment unit in the direction parallel to the optical path of the laser beam so that the first beam diameter or second beam diameter calculated by the first calculation section or second calculation section falls within a predetermined range set beforehand.

In accordance with another aspect of the present invention, there is provided a laser processing apparatus including a chuck table configured to hold a workpiece, a laser processing unit configured to process the workpiece, which is held on the chuck table, by a laser beam irradiation, a processing feed mechanism that carries out processing feed of the chuck table in an X-axis direction relative to the laser processing unit, an indexing feed mechanism that carries out indexing feed of the chuck table in a Y-axis direction, which intersects the X-axis direction at right angles, relative to the laser processing unit, and a notification unit that performs a notification to a worker. The laser processing unit includes a laser oscillator that oscillates a laser, a condenser that focuses a laser beam emitted from the laser oscillator, and a laser beam adjustment system arranged between the laser oscillator and the condenser. The laser beam adjustment system includes a beam adjustment unit having a plurality of lenses arranged in an optical path of the laser beam, a first mirror that reflects the laser beam, which has passed through the beam adjustment unit, to change the optical path thereof, a second mirror that reflects the laser beam, the optical path of which has been changed by the first mirror, to change the optical path thereof, a first camera configured to capture an image of a first light having passed through the first mirror, a second camera configured to capture an image of a second light having passed through the second mirror, and a control unit. The control unit includes a first calculation section configured to calculate a first beam diameter of the first light from pixels in a region having a higher brightness than a preset first brightness in the image captured by the first camera, a second calculation section configured to calculate a second beam diameter of the second light from pixels in a region having a higher brightness than a preset second brightness in the image captured by the second camera, and a lens adjustment section configured to move one of the plurality of lenses of the beam adjustment unit in a direction parallel to the optical path of the laser beam so that the first beam diameter calculated by the first calculation section and the second beam diameter calculated by the second calculation section match each other. The notification unit is configured, if the beam diameter calculated by the first calculation section or second calculation section falls outside a predetermined range during laser processing, to notify the worker accordingly.

According to the laser beam adjustment system, for the adjustment of the laser beam to the parallel light, the lens adjustment section moves one of the lenses of the beam adjustment unit so that the first beam diameter of the first light and the second beam diameter of the second light match each other. According to the laser beam adjustment system, the laser beam can therefore be adjusted to the parallel light without substantial involvement of work by a worker. Therefore, a load on the worker can be reduced, and the laser beam can be easily adjusted to the parallel light.

Preferably, the lens adjustment section may move another lens of the beam adjustment unit so that the beam diameter of the laser beam has a value in the predetermined range set beforehand. The beam diameter of the laser beam can also be easily set at an appropriate value without substantial involvement of work by the worker.

In other words, the present invention can adjust, without substantial involvement of work by a worker, a laser beam so that it has a high parallelism and an appropriate beam diameter. Concerning the adjustment of the laser beam, it is therefore possible to significantly reduce the worker's labor and to successfully suppress human errors. As a consequence, it is possible to suppress effects of apparatus differences among laser oscillators. Substantially the same processing results can hence be obtained in a plurality of laser processing apparatuses.

If the beam diameter of the laser beam falls outside the predetermined range set beforehand during laser processing by the laser processing apparatus, the notification unit notifies the worker of that accordingly. Even if the beam diameter varies during the laser processing, the worker can therefore readily notice such a variation. As a consequence, it is possible to suppress a failure in processing a workpiece.

The above and other objects, features and advantages of the present invention and the manner of realizing them will become more apparent, and the invention itself will best be understood from a study of the following description and appended claims with reference to the attached drawings illustrating a preferred embodiment of the invention.

### BRIEF DESCRIPTION OF THE DRAWINGS

FIG. 1 is a perspective view illustrating the configuration of a laser processing apparatus;

FIG. 2 is a schematic diagram illustrating the configuration of a laser processing unit;

FIG. 3 is a perspective view illustrating the configuration of the laser processing unit;

FIG. 4 is a flow chart illustrating adjustment operations of a laser beam;

FIG. 5 is a schematic view illustrating an example of an image captured by a first camera (or a second camera); and

FIG. 6 is a graph illustrating an example of a relation between pixels, which are located side by side on a straight line that passes through a center of a beam region, and brightnesses thereof with respect to each of the captured image illustrated in FIG. 5 and a similar image captured by the second camera (or the first camera).

### DETAILED DESCRIPTION OF THE PREFERRED EMBODIMENTS

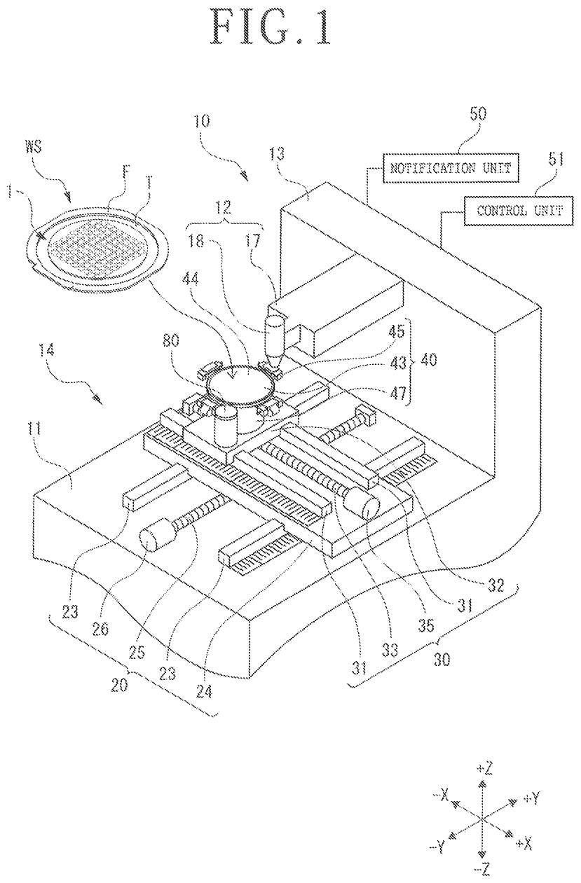

A laser processing apparatus 10 illustrated in FIG. 1 is useful in subjecting a wafer 1 to laser processing. The laser processing apparatus 10 includes a parallelepiped bed 11, an upright wall portion 13 disposed upright on an end portion of the bed 11, a notification unit 50 that performs a notification to a worker, and a control unit 51 that controls individual members of the laser processing apparatus 10.

On an upper surface of the bed 11, a chuck table moving mechanism 14 is disposed to move a chuck table 43. The chuck table moving mechanism 14 carries out processing feed and indexing feed of the chuck table 43 in an X-axis direction and a Y-axis direction, respectively. The chuck table moving mechanism 14 includes a chuck table assembly 40 having the chuck table 43, an indexing feed mechanism 20 that moves the chuck table 43 in an indexing feed direction relative to a laser processing unit (laser beam irradiation unit) 12, and a processing feed mechanism 30 that moves the chuck table 43 in a processing feed direction relative to the laser processing unit 12.

The indexing feed mechanism 20 includes a pair of guide rails 23 extending in the Y-axis direction, a Y-axis table 24 mounted on the guide rails 23, a ball screw 25 extending in parallel to the guide rails 23, and a drive motor 26 that rotates the ball screw 25.

The paired guide rails 23 are arranged in parallel to the Y-axis direction on the upper surface of the bed 11. The Y-axis table 24 is arranged on the paired guide rails 23 slidably along these guide rails 23. On the Y-axis table 24, the processing feed mechanism 30 and the chuck table assembly 40 are mounted.

The ball screw 25 is maintained in threaded engagement with nut portions (not illustrated) arranged on a side of a lower surface of the Y-axis table 24. The drive motor 26 is connected to an end portion of the ball screw 25, and rotationally drives the ball screw 25. Accompanied by the rotational drive of the ball screw 25, the Y-axis table 24, the processing feed mechanism 30 and the chuck table assembly 40 move in an indexing feed direction (in the Y-axis direction that intersects the X-axis direction at right angles) along the guide rails 23.

The processing feed mechanism 30 includes a pair of guide rails 31 extending in the X-axis direction, an X-axis table 32 mounted on the guide rails 31, a ball screw 33 extending in parallel to the guide rails 31, and a drive motor 35 that rotates the ball screw 33. The paired guide rails 31 are arranged in parallel to the X-axis direction on an upper surface of the Y-axis table 24. The X-axis table 32 is disposed on the paired guide rails 31 slidably along these guide rails 31. On the X-axis table 32, the chuck table assembly 40 and a power meter 80 are mounted.

The ball screw 33 is maintained in threaded engagement with nut portions (not illustrated) arranged on a side of a lower surface of the X-axis table 32. The drive motor 35 is connected to an end portion of the ball screw 33, and rotationally drives the ball screw 33. Accompanied by the rotational drive of the ball screw 33, the X-axis table 32 and the chuck table assembly 40 move in a processing feed direction (in the X-axis direction) along the guide rails 31.

The chuck table assembly 40 is used to hold the wafer 1. As illustrated in FIG. 1, the wafer 1 that is an example of a workpiece is held as a wafer unit W, which includes a ring frame F, an adhesive tape S, and the wafer 1, on the chuck table assembly 40.

The chuck table assembly 40 has the chuck table 43 that holds the wafer 1, clamps 45 arranged around the chuck table 43, and a θ table 47 that supports the chuck table 43 thereon. The θ table 47 is arranged rotatably in an XY-plane on an upper surface of the X-axis table 32. The chuck table 43 is a member for holding the wafer 1 under suction. The chuck table 43 is formed in a disc shape, and is arranged on the θ table 47.

On an upper surface of the chuck table 43, a holding surface is formed including a porous ceramic material. This holding surface is in communication with a suction source (not illustrated). Around the chuck table 43, the clamps 45 are arranged as many as four. Each clamp includes a supporting arm. The four clamps 45 are activated by an air actuator (not illustrated), whereby the ring frame F around the wafer 1 held on the chuck table 43 is held and fixed in four directions.

The upright wall portion 13 of the laser processing apparatus 10 is disposed upright behind the chuck table moving mechanism 14. On a front surface of the upright wall portion 13, the laser processing unit 12 is arranged to process the wafer 1, which is held on the chuck table 43, by a laser beam irradiation.

The laser processing unit 12 includes a processing head 18 from which the laser beam is applied to the wafer 1, and an arm portion 17 that supports the processing head 18. The arm portion 17 protrudes from the upright wall portion 13 in a direction toward the chuck table moving mechanism 14. The processing head 18 is supported on a distal end of the arm portion 17 so that the processing head 18 opposes the chuck table 43 or the power meter 80 in the chuck table assembly 40 in the chuck table moving mechanism 14.

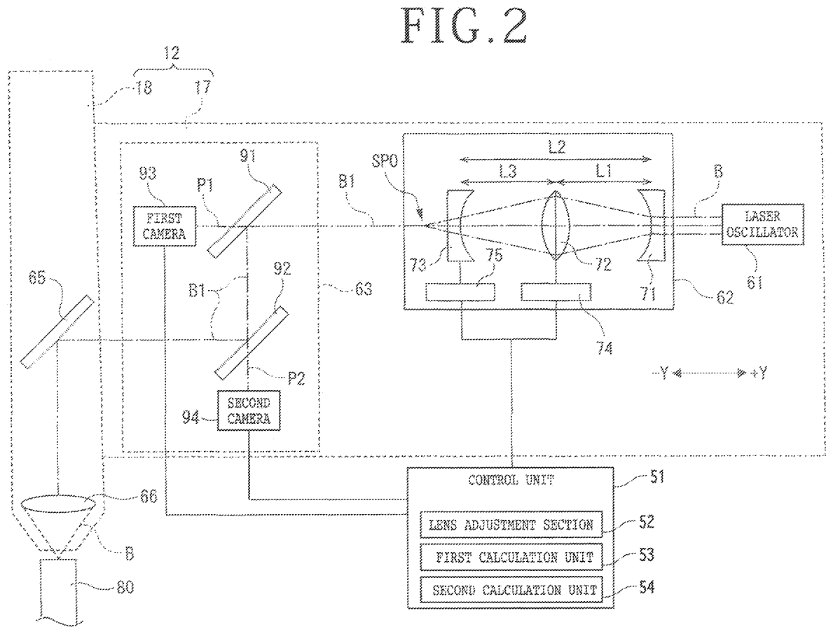

In the arm portion 17 and the processing head 18, an optical system of the laser processing unit 12 is arranged. As illustrated in FIG. 2, the laser processing unit 12 includes, in the arm portion 17, a laser oscillator 61 that emits a laser beam B, a beam expander 62 that adjusts the laser beam B, and a beam measurement system 63 for measuring the parallelism and beam diameter of the laser beam B.

On the other hand, the laser processing unit 12 has, in the processing head 18, a reflection mirror 65 that reflects the laser beam B, and a condenser (condenser lens) 66 that focuses and outputs the laser beam B. The laser oscillator 61 is, for example, a solid-state laser beam source. The laser oscillator 61 emits the laser beam B in a −Y direction in the arm portion 17.

The beam expander 62 corresponds to an example of a beam adjustment unit having a plurality of lenses. The beam expander 62 is used to adjust the laser beam B emitted from the laser oscillator 61.

The laser beam B adjusted by the beam expander 62 passes through the beam measurement system 63, and enters the reflection mirror 65 in the processing head 18. The laser beam B is reflected in a −Z direction by the reflection mirror 65, and is guided to the condenser 66. The condenser 66 focuses the laser beam B to be applied in the −Z direction toward an outside of the processing head 18.

When processing the wafer 1 illustrated in FIG. 1, the wafer 1 on the chuck table 43 is irradiated with the laser beam B that has been focused by the condenser 66. When adjusting the laser beam B, on the other hand, the laser beam B is applied to the power meter 80 as illustrated in FIG. 2.

The notification unit 50 is, for example, a touch panel including a speaker, and a variety of information such as conditions for processing by the laser processing apparatus 10 is presented by an image and a voice message. The notification unit 50 is also used to set various information such as processing conditions. As appreciated from the foregoing, the notification unit 50 functions not only as input means for inputting information but also as presentation means for presenting the information so inputted.

A description will next be made about the laser beam adjustment system of the laser processing apparatus 10. The laser beam adjustment system adjusts the laser beam B emitted from the laser oscillator 61 to a parallel light, and also adjusts the beam diameter of the laser beam B.

The laser beam adjustment system of the laser processing apparatus 10 includes the optical system of the laser processing unit 12 built in the above-described arm portion 17 and processing head 18, and is arranged between the laser oscillator 61 and the condenser 66. The laser beam adjustment system also includes the control unit 51 illustrated in FIG. 2.

As illustrated in FIG. 2, the beam expander 62 includes, in an optical path B1 of the laser beam B, a first concave lens 71, a convex lens 72, and a second concave lens 73. The first concave lens 71, the convex lens 72, and the second concave lens 73 have focal points located on the optical path B1 of the laser beam B.

The first concave lens 71 is fixed in the beam expander 62. On the other hand, the convex lens 72 and the second concave lens 73 are configured to be movable in a direction parallel to the optical path B1 of the laser beam B. The beam expander 62 therefore includes a convex lens moving mechanism 74 and a second concave lens moving mechanism 75. The convex lens moving mechanism 74 moves the convex lens 72 in the direction parallel to the optical path B1 of the laser beam B. The second concave lens moving mechanism 75 moves the second concave lens 73 in the direction parallel to the optical path B1 of the laser beam B.

If the second concave lens 73 is moved, a distance L2 between the first concave lens 71 and the second concave lens 73 changes. As a consequence, it is possible to adjust the parallelism of the laser beam B outputted from the beam expander 62. A distance between the convex lens 72 and the second concave lens 73 after the adjustment of the parallelism will be assumed to be L3.

The term “parallelism of the laser beam B” means the degree of uniformity of the beam diameter (width) of the laser beam B along the optical path B1. Being high in parallelism means that the laser beam B is a parallel light or a collimated beam, in other words, the beam diameter of the laser beam B is substantially uniform along the optical path B1. Being low in parallelism, in contrast, means that the beam diameter of the laser beam B spreads out (or narrows) along the optical path B1.

If the convex lens 72 is moved, a distance L1 between the first concave lens 71 and the convex lens 72 are changed. As a consequence, the size of the beam diameter of the laser beam B can be adjusted. When moving the convex lens 72, it is desired to maintain the distance L3 after the adjustment of the parallelism. A position SP0 on the optical path B1 as illustrated in FIG. 2 indicates the mutually registered positions of the focal points of the convex lens 72 and the second concave lens 73.

The beam measurement system 63 located in a subsequent stage of the beam expander 62 includes a first mirror 91 and a second mirror 92 that reflect the laser beam B, a first camera 93 arranged on a back side of the first mirror 91, and a second camera 94 arranged on a back side of the second mirror 92.

The first mirror 91 reflects the laser beam B having passed through the beam expander 62 to change the direction of the optical path B1 of the laser beam B. The second mirror 92 further reflects the laser beam B the optical path of which has been changed by the first mirror 91, so that the optical path B1 is changed further. The laser beam B reflected by the second error 92 enters the reflection mirror 65.

These first mirror 91 and the second mirror 92 reflect the applied laser beam B substantially in its entirety, but allow the laser beam B to pass at a very low rate (0.05% to 0.1%).

Then, the first camera 93 arranged on the back side of the first mirror 91 captures an image of a first light P1 that is a light having passed through the first mirror 91. On the other hand, the second camera 94 arranged on the back side of the second mirror 92 captures an image of a second light P2 that is a light having passed through the second mirror 92.

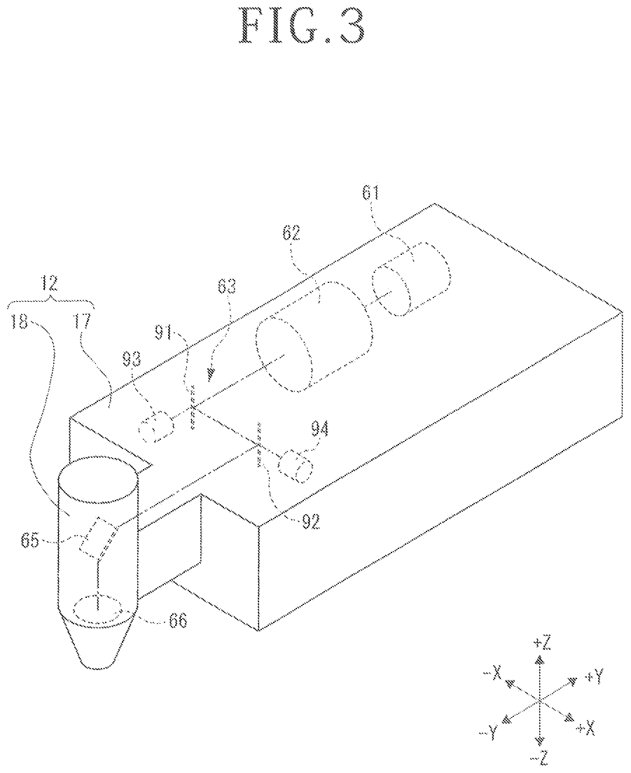

As illustrated in FIG. 3, the laser beam oscillator 61, the beam expander 62, and the first mirror 91, the second mirror 92, the first camera 93 and the second camera 94 of the beam measurement system 63 are arranged in the arm portion 17 so that the laser beam B is reflected in the XY plane by the first mirror 91 and the second mirror 92. Further, the reflection mirror 65 and the condenser 66 are arranged in the processing head 18 so that they are located side by side along a Z-axis direction.

The power meter 80 is arranged downstream of the second mirror 92, the reflection mirror 65, and the condenser 66 in the optical path B1 of the laser beam B. The power meter 80 is exposed to the laser beam B focused by the condenser 66. As a consequence, the power meter 80 measures the amount of energy (illuminance) of the applied laser beam B.

The control unit 51 controls the individual elements of the laser processing apparatus 10 to perform processing on the wafer 1. The control unit 51 also controls the optical system of the laser processing unit 12 and the power meter 80 illustrated in FIG. 2 to perform the adjustment of the laser beam B.

As illustrated in FIG. 2, the control unit 51 includes, as elements, a lens adjustment section 52, a first calculation section 53, and a second calculation section 54. Adjustment operations of the laser beam B under control by the control unit 51 will hereinafter be described along with functions of the elements of the control unit 51.

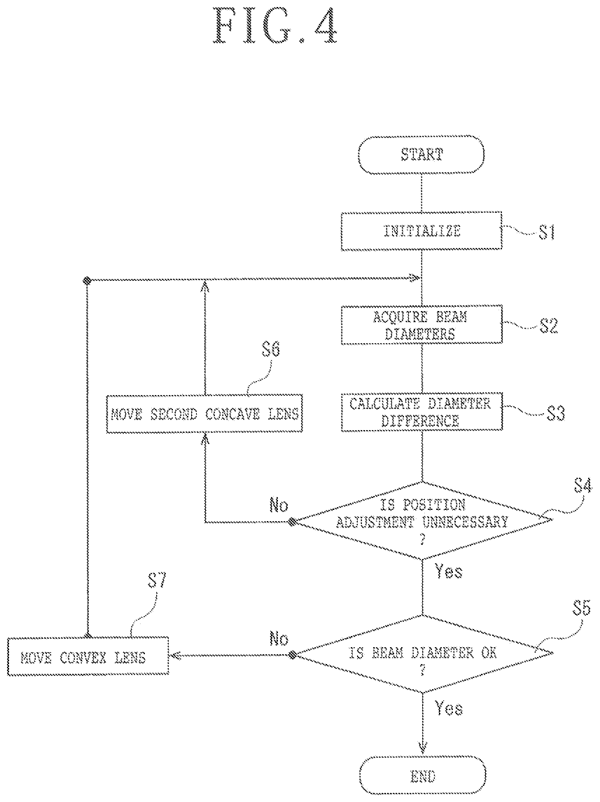

FIG. 4 is a flow chart illustrating the adjustment operations of the laser beam B by the control unit 51. As illustrated in this figure, the control unit 51 first sets the positions of the convex lens 72 and the second concave lens 73 of the laser beam adjustment system at predetermined initial positions (initialization: S1). The control unit 51 also controls the chuck table moving mechanism 14 to arrange the power meter 80 right below the condenser 66 in the processing head 18.

Subsequently, the control unit 51 controls the laser oscillator 61 to emit the laser beam B. The power meter 80 is irradiated with the laser beam B emitted from the laser oscillator 61 via the reflection mirror 65 and the condenser 66.

Next, the control unit 51 performs beam diameter acquisition processing (S2). Described specifically, the control unit 51 controls the first camera 93 to capture an image of the first light P1 having passed through the first mirror 91, and also controls the second camera 94 to capture an image of the second light P2 having passed through the second mirror 92.

The first calculation section (the first beam diameter calculation section) 53 of the control unit 51 then calculates the beam diameter of the laser beam B (the first light P1) from pixels in a region having a higher brightness than a preset first brightness in the image captured by the first camera 93. Similarly, the second calculation section (the second beam diameter calculation section) 54 of the control unit 51 calculates the beam diameter of the laser beam B (the second light P2) from pixels in a region having a higher brightness than a preset second brightness in the image captured by the second camera 94.

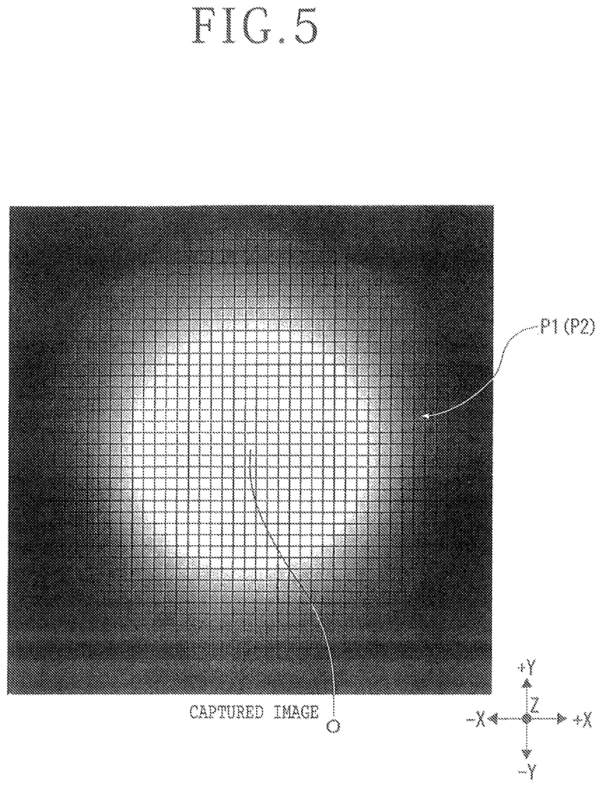

FIG. 5 illustrates an example of an image captured by the first camera 93 (or the second camera 94). As illustrated in this figure, the captured image is a multi-gradation image containing, for example, a plurality of 5.5 by 5.5 μm square pixels. In the captured image, a color close to white is presented near a center pixel O corresponding to a central part of high intensity (brightness) in the first light P1 (or the second light P2). As the distance from this center pixel O increases, the pixels of the captured image are presented in a color closer to black.

The first calculation section 53 and the second calculation section 54 calculate, based on such captured images, the beam diameters of the first light P1 and the second light P2 of the laser beam B, respectively.

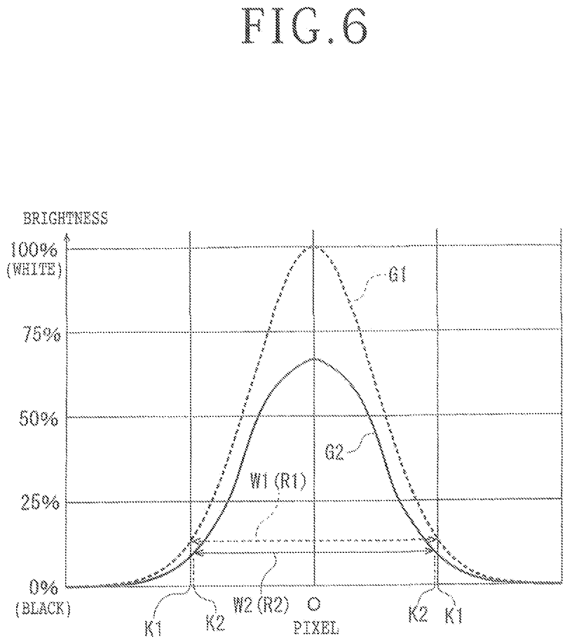

FIG. 6 illustrates, with respect to each of the captured images based on the first light P1 and the second light P2, an example of a brightness curve presenting a relation between pixels, which are located side by side on a straight line that passes through the center pixel O, and brightnesses thereof.

In the examples illustrated in FIG. 6, a brightness curve G1 corresponding to the first light P1 is presented by a broken line. On the other hand, a brightness curve G1 corresponding to the second light P2 is presented by a solid line. Concerning each of these brightness curves G1 and G2, the brightness of the center pixel O presented in FIG. 5 has a maximum value, and the brightness of each pixel decreases as its distance from the center pixel O increases. Further, the maximum value (100%; corresponding to white color) of the brightness on the brightness curve G1 is greater than the maximum value (approx. 70%; corresponding to gray color) of the brightness on the brightness curve G2.

As illustrated in FIG. 6, the first calculation section 53 then calculates a first beam diameter R1, which is the beam diameter of the first light P1, as a width W1 between pixels that have a brightness 1/e² (13.5%) times the value of the peak intensity of the brightness curve G1 corresponding to the first light P1.

In other words, the first calculation section 53 determines first border pixels K1 (at two locations) as the pixels having the brightness 1/e² (13.5%) times the value of the peak intensity. The first calculation section 53 next determines that the pixels on an inner side than the first border pixels K1 are the pixels in the region having the brightness higher than the preset first brightness. The first calculation section 53 then calculates the first beam diameter R1, which is the beam diameter of the first light P1, as the width W1 between the two first border pixels K1.

Similarly, the second calculation section 54 calculates, as illustrated in FIG. 6, a second beam diameter R2, which is the beam diameter of the second light P2, as a width W2 between pixels that have a brightness 1/e² times the value of the peak intensity of the brightness curve G2 corresponding to the second light P2.

In other words, the second calculation section 54 determines second border pixels K2 (at two locations) as the pixels having the brightness 1/e² (13.5%) times the value of the peak intensity of the brightness curve G2 corresponding to the second light P2. The second calculation section 54 next determines that the pixels on an inner side than the second border pixels K2 are the pixels in the region having the brightness higher than the preset second brightness. The second calculation section 54 then calculates the second beam diameter R2, which is the beam diameter of the second light P2, as the width W2 between the two second border pixels K2.

The lens adjustment section 52 of the control unit 51 next moves the second concave lens 73 of the beam expander 62 in the direction parallel to the optical path B1 of the laser beam B so that the first beam diameter R1 of the first light P1 as calculated by the first calculation section 53 and the second beam diameter R2 of the second light P2 as calculated by the second calculation section 54 match each other.

For example, the control unit 51 calculates a difference between the first beam diameter R1 and the second beam diameter R2 (S3 in FIG. 4). The control unit 51 then determines whether the diameter difference thus calculated falls within a preset tolerance. Described specifically, if the diameter difference thus calculated is determined not to fall within the tolerance, the control unit 51, based on the determination result, makes an adjustment to the position of the second concave lens 73 (see FIG. 2) in the beam expander 62 (S4).

In other words, any diameter difference within the preset tolerance means that the laser beam B has a substantially similar beam diameter at both the first mirror 91 and the second mirror 92 located apart from each other in the direction of the optical path B1 of the laser beam B.

Accordingly, in this case, the control unit 51 therefore determines that the laser beam B is a parallel light having high parallelism, and hence determines that a position adjustment is unnecessary (“Yes” in S4). In contrast, any diameter difference greater than the tolerance means that the laser beam B does not have a substantially similar beam diameter at both the first mirror 91 and the second mirror 92.

Accordingly, in this case, the control unit 51 therefore determines that the laser beam B is not a parallel light, and hence determines that a position adjustment is necessary (“No” in S4). In this case, the lens adjustment section 52 of the control unit 51 controls the second concave lens moving mechanism 75 to move the second concave lens 73 in the direction parallel to the optical path B1 (S6).

Described specifically, if the second beam diameter R2 is greater than the first beam diameter R1 by more than the tolerance, the control unit 51 determines that the laser beam B has spread out. In this case, the lens adjustment section 52 moves the second concave lens 73 illustrated in FIG. 2 in the −Y direction to make greater the distance L2 between the first concave lens 71 and the second concave lens 73. As a consequence, the laser beam B can be suppressed from spreading out.

If the first beam diameter R1 is greater than the second beam diameter R2 by more than the tolerance, in contrast, the control unit 51 determines that the laser beam B has narrowed. Accordingly, in this case, the lens adjustment section 52 moves the second concave lens 73 in a +Y direction to make smaller the distance L2. As a consequence, the laser beam B can be suppressed from narrowing.

In the manner described above, the diameter difference between the first beam diameter R1 and the second beam diameter R2 is reduced to the preset tolerance or smaller, and the processing operations of S2 to S4 are repeated until the control unit 51 determines that the laser beam B is a parallel light.

After the laser beam B has become the parallel light, the control unit 51 determines whether the beam diameter (the first beam diameter R1 or the second beam diameter R2) is in a predetermined range set beforehand, for example, in a range of 1.63 mm±50 μm (S5).

If the beam diameter is in the predetermined range (“Yes” in S5), the control unit 51 ends the processing. If the beam diameter is not in the predetermined range (“No” in S5), in contrast, the lens adjustment section 52 of the control unit 51 controls the convex lens moving mechanism 74 so that the beam diameter has a value in the predetermined range, thereby moving the convex lens 72 in the direction parallel to the optical path B1 of the laser beam B (S7).

Described specifically, if the beam diameter is greater than the predetermined range, the lens adjustment section 52 controls the convex lens moving mechanism 74 to make smaller the distance L1 between the first concave lens 71 and the convex lens 72. As a consequence, the beam diameter of the laser beam B can be made smaller.

If the beam diameter is smaller than the predetermined range, in contrast, the lens adjustment section 52 controls the convex lens moving mechanism 74 to make greater the distance L1 between the first concave lens 71 and the convex lens 72. As a consequence, the beam diameter of the laser beam B can be made greater.

Subsequently, the control unit 51 returns the processing to S2, and the processing operations of S2 to S7 are repeated until the laser beam B becomes a parallel light and its beam diameter increases to a value in the predetermined range. When the laser beam B has become the parallel light and its beam diameter has increased to the value in the predetermined range, the control unit 51 ends the adjustment operations of the laser beam B. Using the notification unit 50, the control unit 51 then notifies the worker of that accordingly.

After an initiation of laser processing by the worker, the control unit 51 performs the processing operation presented as S3 in FIG. 4 as needed, whereby the difference between the first beam diameter R1 and the second beam diameter R2 and/or the first beam diameter R1 or the second beam diameter R2 (one of the beam diameters) is acquired.

If the diameter difference between the first beam diameter R1 and the second beam diameter R2 falls outside the preset tolerance or if one of the beam diameters falls outside the predetermined range set beforehand during the laser processing, the control unit 51 controls the notification unit 50 to notify the worker of that accordingly.

As has been described above, to adjust the laser beam B to the parallel light by the laser beam adjustment system according to this embodiment, the beam diameter acquisition processing (FIG. 4; S2) is performed by the control unit 51, and the control unit 51 then calculate the difference between the first beam diameter R1 of the first light P1 and the second beam diameter R2 of the second light P2, that is, the diameter difference (S3). In order to make this diameter difference fall within the preset tolerance, the lens adjustment section 52 next controls the second concave lens moving mechanism 75 to move the second concave lens 73 in the direction parallel to the optical path B1 (S4, S6). These processing operations are then repeated until the above-described diameter difference falls within the preset tolerance.

According to this embodiment, the laser beam B can therefore be adjusted to the parallel light without substantial involvement of work by the worker. Therefore, a load on the worker can be reduced, and the laser beam B can be easily adjusted to the parallel light.

In this embodiment, the lens adjustment section 52 further controls the convex lens moving mechanism 74 to move the convex lens 72 in the direction parallel to the optical path B1 so that the beam diameter (the first beam diameter R1 or the second beam diameter R2) of the laser beam B has a value in the predetermined range set before hand (S7). The processing operations of S2 to S7 are then repeated until the beam diameter has the value in the predetermined range. In this embodiment, the beam diameter of the laser beam B can also be easily set at an appropriate value without substantial involvement of work by the worker.

As has been described above, it is possible in this embodiment to adjust, without substantial involvement of work by the worker, the laser beam B so that it has a high parallelism and an appropriate beam diameter. In this embodiment, it is therefore possible to significantly reduce the worker's labor and to successfully suppress human errors, both, with respect to the adjustment of the laser beam B.

As a consequence, it is possible to suppress effects of the apparatus differences (for example, differences in beam diameter) among laser oscillators. Substantially the same processing results can hence be obtained in a plurality of laser processing apparatuses.

In this embodiment, the control unit 51 acquires the difference between the first beam diameter R1 and the second beam diameter R2 and the beam diameter (the first beam diameter R1 or the second beam diameter R2) as needed during the laser processing. If the diameter difference falls outside the preset tolerance or the beam diameter falls outside the predetermined range set beforehand, the notification unit 50 notifies the worker of that accordingly.

Even if the laser beam B no longer becomes the parallel light or the beam diameter varies during the laser processing, the worker can therefore notice such a change in this embodiment. As a consequence, it is possible to suppress a failure in processing the wafer 1.

In this embodiment, as illustrated in FIG. 2, the second camera 94 is arranged on the back side of the second mirror 92 to capture the image of the second light P2 that is the light having passed through the second mirror 92. As an alternative, the second camera 94 may be configured to be arranged on the back side of the reflection mirror 65 in the processing head 18 and to capture an image of a light passed through the reflection mirror 65.

In addition to the first camera 93 and the second camera 94 illustrated in FIG. 2, a third camera may also be arranged on a back side of the reflection mirror 65 to capture an image of a light passed through the reflection mirror 65. In this case, the control unit 51 may further include a third calculation section to calculate the beam diameter of the laser beam B from pixels in a range brighter than a preset third brightness in the image captured by the third camera. The lens adjustment section 52 may then move the second concave lens 73 in the direction parallel to the optical path B1 of the laser beam B in the beam expander 62 so that the beam diameter calculated by the first calculation section 53, the beam diameter calculated by the second calculation section 54, and the beam diameter calculated by the third calculation section match one another.

In this embodiment, the images captured by the first camera 93 and the second camera 94 are multi-gradation images. As an alternative, these captured images may be binarized images.

In the example illustrated in FIG. 6, the maximum value of the brightness on the brightness curve G1, which corresponds to the first light P1 having passed through the first mirror 91, is higher than the maximum value of the brightness on the brightness curve G2, which corresponds to the second light P2 having passed through the second mirror 92. In this regard, the brightness of the second light P2 may become higher than that of the first light P1. It is to be noted that the brightness of a light passed through a mirror has a different value depending on the type of the mirror.

The laser processing unit 12 according to the embodiment may be a processing unit for subjecting the wafer 1 to ablation processing, or a processing unit for performing stealth dicing processing to form modified layers inside the wafer 1.

The present invention is not limited to the details of the above-described preferred embodiment. The scope of the invention is defined by the appended claims and all changes and modifications as fall within the equivalence of the scope of the claims are therefore to be embraced by the invention.

What is claimed is:

1. A laser beam adjustment system for adjusting a laser beam emitted from a laser oscillator to a parallel light, comprising:
a beam adjustment unit having a plurality of lenses arranged in an optical path of the laser beam;
a first mirror that reflects the laser beam having passed through the beam adjustment unit, to change the optical path of the laser beam;
a second mirror that reflects the laser beam, the optical path of the laser beam having been changed by the first mirror, to change the optical path of the laser beam;
a first camera configured to capture an image of a first light having passed through the first mirror;
a second camera configured to capture an image of a second light having passed through the second mirror; and
a control unit,
wherein the control unit includes a first calculation section configured to calculate a first beam diameter of the first light from pixels in a region having a higher brightness than a preset first brightness in the image captured by the first camera,
a second calculation section configured to calculate a second beam diameter of the second light from pixels in a region having a higher brightness than a preset second brightness in the image captured by the second camera, and
a lens adjustment section configured to move one of the plurality of lenses of the beam adjustment unit in a direction parallel to the optical path of the laser beam so that the first beam diameter calculated by the first calculation section and the second beam diameter calculated by the second calculation section match each other.

2. The laser beam adjustment system according to claim 1, wherein
the lens adjustment section is configured to move another one of the plurality of lenses of the beam adjustment unit in the direction parallel to the optical path of the laser beam so that the first beam diameter or second beam diameter calculated by the first calculation section or second calculation section falls within a predetermined range set beforehand.

3. A laser processing apparatus comprising:
a chuck table configured to hold a workpiece;
a laser processing unit configured to process the workpiece held on the chuck table, by a laser beam irradiation;
a processing feed mechanism that carries out processing feed of the chuck table in an X-axis direction relative to the laser processing unit;
an indexing feed mechanism that carries out indexing feed of the chuck table in a Y-axis direction intersecting the X-axis direction at right angles, relative to the laser processing unit; and
a notification unit that performs a notification to a worker,
wherein the laser processing unit includes
a laser oscillator that oscillates a laser,
a condenser that focuses a laser beam emitted from the laser oscillator, and
a laser beam adjustment system arranged between the laser oscillator and the condenser,
the laser beam adjustment system including
a beam adjustment unit having a plurality of lenses arranged in an optical path of the laser beam,
a first mirror that reflects the laser beam having passed through the beam adjustment unit, to change the optical path of the laser beam,
a second mirror that reflects the laser beam, the optical path of the laser beam having been changed by the first mirror, to change the optical path of the laser beam,
a first camera configured to capture an image of a first light having passed through the first mirror,
a second camera configured to capture an image of a second light having passed through the second mirror, and
a control unit, and
the control unit including
a first calculation section configured to calculate a first beam diameter of the first light from pixels in a region having a higher brightness than a preset first brightness in the image captured by the first camera,
a second calculation section configured to calculate a second beam diameter of the second light from pixels in a region having a higher brightness than a preset second brightness in the image captured by the second camera, and
a lens adjustment section configured to move one of the plurality of lenses of the beam adjustment unit in a direction parallel to the optical path of the laser beam so that the first beam diameter calculated by the first calculation section and the second beam diameter calculated by the second calculation section match each other, and
wherein the notification unit is configured, if the beam diameter calculated by the first calculation section or second calculation section falls outside a predetermined range during laser processing, to notify the worker of that accordingly.
